(19) United States
(12) Patent Application Publication
(10) Pub. No.: US 2008/0010886 A1
(43) Pub. Date: Jan. 17, 2008

(54) POSTCARD

(76) Inventor: Chun-Chi FAN CHIANG, Sinwu Hsiang (TW)

Correspondence Address: PATENTTM.US, P. O. BOX 82788, PORTLAND, OR, 97282-0788, US

(21) Appl. No.: 11/772,957

(22) Filed: Jul. 3, 2007

(30) Foreign Application Priority Data
Jul. 11, 2006 (TW) 095212122

(51) Int. Cl. B42D 15/02

(52) U.S. Cl. 40/773

(57) ABSTRACT

A postcard has at least one wooden layer. The wooden layer is hard and has an outer front surface, an outer rear surface and a design. The outer rear surface is smooth. The design is embossed, stamped, etched or burned on the outer front surface and may be a pattern, words or the like.

### BACKGROUND OF THE INVENTION

1. Field of the Invention

The present invention relates to a postcard.

2. Description of the Related Art

With the development of the Internet and the proliferation of personal computers, sending information by email is more convenient and faster for modern people than sending a conventional letter or postcard.

However, travelers still purchase postcards that are cheap and have professional quality pictures of local sites and scenery. They usually simply write down some personal message on the postcard and mail it to their families, friends or even to themselves to save as a souvenir.

A conventional postcard comprises a front and a rear and is simply a piece of paper. The front has a picture of local scenery, a pattern, a general message or the like. The rear is usually a simple form to accommodate a message, an address and a stamp. Because the conventional postcard is paper, it is susceptible to being easily folded, bent and worn especially during transportation and handling in the postal system.

### SUMMARY OF THE INVENTION

The main objective of the present invention is to provide a postcard that is decorative and durable.

To achieve the foregoing objective, a postcard in accordance with the present invention comprises at least one wooden layer. The wooden layer is hard and comprises an outer front surface, an outer rear surface and a design. The outer rear surface is smooth. The design is embossed, stamped, etched or burned on the outer front surface and may be a pattern, words or the like.

The postcard as described keeps the postcard from being marred, wrinkled or otherwise damaged even when subjected to rain or abusive handling. Consequently, the value as a collectable or a decoration will not be degraded.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a postcard in accordance with the present invention from the front; and

FIG. 2 is a perspective view with a detached cord of a postcard in accordance with the present invention.

FIG. 3 is a perspective view of the postcard in FIG. 1 from the rear.

### DETAILED DESCRIPTION OF THE PREFERRED EMBODIMENTS

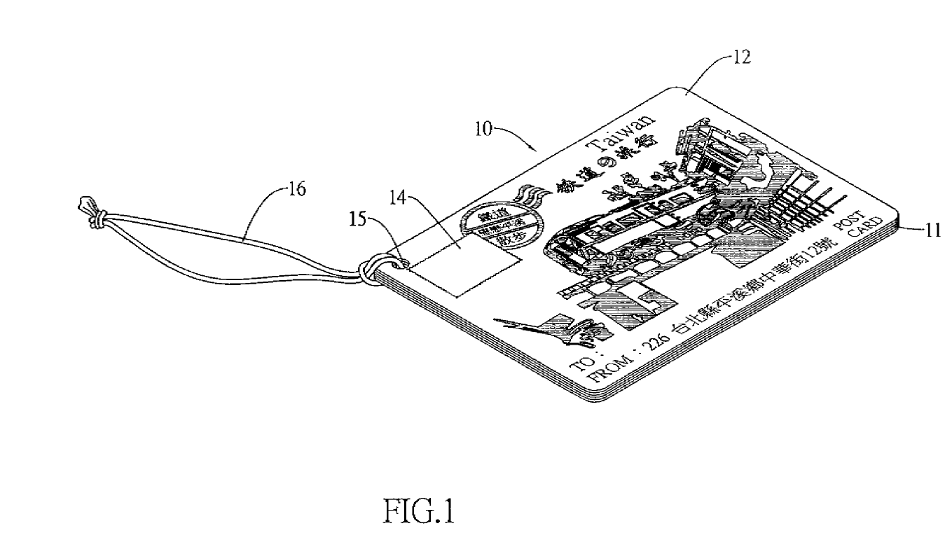

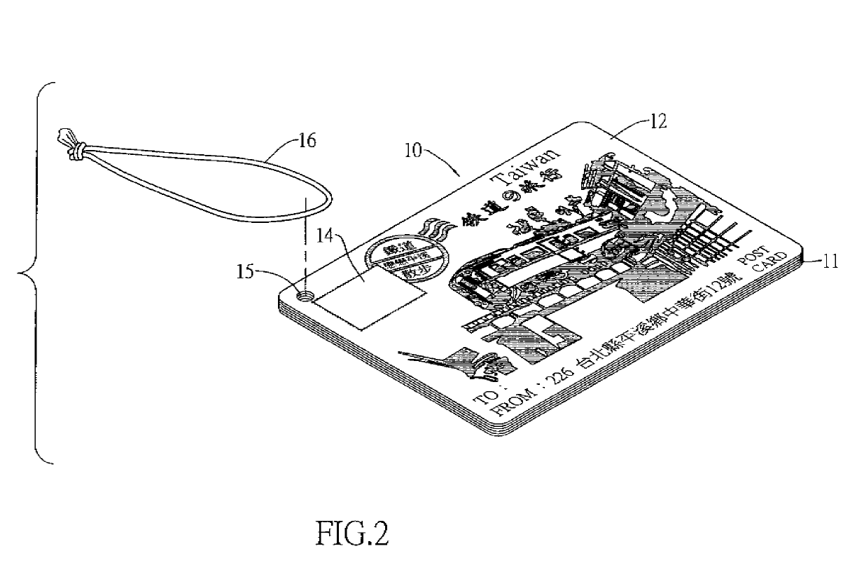

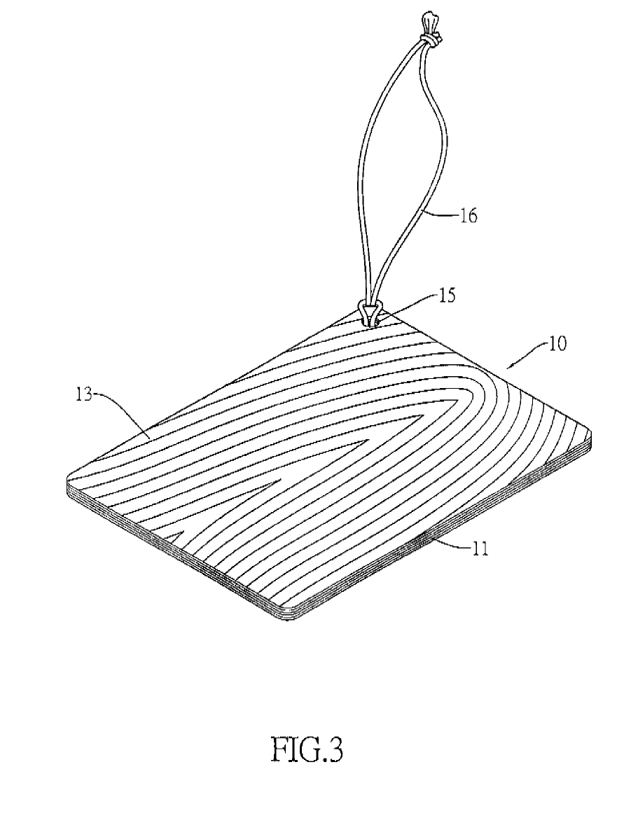

With reference to FIGS. 1 and 2, a postcard (10) in accordance with the present invention has at least one wooden layer (11) and an optional cord (16). With further reference to FIG. 3, the at least one wooden layer (11) may be multiple wooden layers (11) and has an outer front surface (12), an outer rear surface (13), an outer edge and an optional through hole (15).

The multiple wooden layers (11) are laminated.

The outer front surface (12) has a design and an optional stamp surface (14). The design may be in relief on or stamped, etched or burned into the front surface (12) and may depict a famous scene, historical event or the like.

The outer rear surface (13) is smooth for writing message on.

The through hole (15) is formed through the postcard near the edge.

The cord (16) is mounted through the through hole (15) and can be used to hang the postcard (10) as a decoration.

The postcard (10) as described has the following advantages. Since the postcard (10) is at least one wooden layer (11), the postcard (10) is hard, durable and significantly less susceptible to damage than a conventional postcard. Furthermore, the postcard (10) can be used as a decoration.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A postcard comprising at least one wooden layer, the at least one wooden layer having
an outer front surface having a design;
an outer rear surface being smooth; and
an outer edge.

2. The postcard as claimed in claim 1 wherein
the at least one wooden layer is multiple wooden layers being laminated and further has a through hole formed through the postcard near the edge; and
the postcard further comprises a cord being mounted through the through hole.

3. The postcard as claimed in claim 1, wherein the outer front surface further has a stamp surface.
